(19) United States
(12) Patent Application Publication
(10) Pub. No.: US 2016/0159162 A1
(43) Pub. Date: Jun. 9, 2016

(54) Pneumatic tire for use on row-crop field sprayers and other like farm machinery

(71) Applicant: The Goodyear Tire & Rubber Company, Akron, OH (US)

(72) Inventors: Mark L. Bonko, Uniontown, OH (US); Timothy Michael Rooney, Munroe Falls, OH (US)

(21) Appl. No.: 15/040,407

(22) Filed: Feb. 10, 2016

Related U.S. Application Data
(63) Continuation of application No. 12/797,863, filed on Jun. 10, 2010.
Application No. 12/797,863 is a continuation of application No. 10/324,662, filed on Dec. 20, 2002, now abandoned.

(51) Int. Cl. B60C 11/03

(52) U.S. Cl. CPC B60C 11/0311; B60C 11/0302; B60C 11/033; B60C 2011/0313

(57) ABSTRACT

A pneumatic tire for use on row-crop field sprayers having lugs configured for providing improved traction, load-handling capability, and stability. The leading edge of each lug is curvilinear such that outside corners are absent. Elimination of outside corners removes stress concentration points that would otherwise degrade tire performance under the conditions of high loading and fast speed. The lugs provide a significant load-carrying capacity without sacrificing attributes such as wet and dry traction, tread cleaning and hard surface roading.

### CROSS-REFERENCE TO RELATED APPLICATIONS

This application is a continuing application of U.S. application Ser. No. 12/797,863, filed Jun. 10, 2010 (pending), which was a continuing application of U.S. application Ser. No. 10/324,662, filed Dec. 20, 2002 (abandoned), both of which are hereby incorporated by reference herein in their entireties.

### TECHNICAL FIELD

The present invention generally relates to tires and, more specifically, to pneumatic tires for row-crop field sprayers and like agricultural machinery.

### BACKGROUND

Self-propelled row-crop field sprayers are specialized agricultural machinery for applying liquids, such as fertilizers or insecticides, to crops planted and grown in multiple parallel rows. Adjacent pairs of rows are tightly spaced for maximizing the plant density of the row crop being grown. As a result, row-crop field sprayer tires have a narrow section width and a high aspect ratio so that the tire can travel within the intra-row space. Because row-crop field sprayers are extremely massive agricultural machines, their pneumatic tires must have the ability to carry large loads. Pneumatic tires for the row-crop field sprayer also have to have a large rim diameter so that the field sprayer can clear the plants in the crop rows. Moreover, the pneumatic tires must exhibit good traction in either wet or dry conditions. In addition, row-crop field sprayer tires must be designed to withstand hard surface roading as the row-crop field sprayer is moved on paved roads between fields at a transport speed significantly faster than the service speed in the field.

As the spacing between adjacent rows has narrowed for increasing the crop density, a need has arisen for narrowed pneumatic tires for row-crop field sprayer service. Because the tire load increases as the footprint narrows, conventional agricultural pneumatic tires cannot satisfy the full range of performance and design parameters required for row-crop field sprayer service. In particular, the lugs of such conventional agricultural pneumatic tires experience adverse consequences, such as cracking, tearing or, at the least, irregular wear patterns, resulting from hard surface roading.

The inferior performance of conventional agricultural pneumatic tires arises from the faceted leading edge of the lugs, which define outside corners that provide stress concentration points under the conditions of high loading and fast speed. The leading edge experiences a significantly larger strain than the lug's trailing edge so that the outside corners on the leading edge experience significant strains. In particular, tires having conventional lug widths are prone to deflection which creates cracking, tearing and irregular wear patterns. Therefore, conventional agricultural pneumatic tires for service with row-crop field sprayers are particularly susceptible to the aforementioned adverse consequences, which significantly reduce tire durability.

For these and other reasons, it would be desirable to provide a pneumatic agricultural tire for row-crop field sprayer services that can provide adequate wet and dry traction, that can carry heavy loads on a narrow-width ground-contacting footprint, and that does not experience any significant adverse consequences due from hard surface roading.

### SUMMARY

The invention is directed to high-profile pneumatic tires for row-crop field sprayers, and like agricultural machinery having a high center of mass, that are capable of rolling between adjacent crop rows. A pneumatic tire constructed according to the principles of the invention includes a casing having an axis of rotation, and a tread disposed radially outward of the casing. The tread includes a circumferential inner tread and a plurality of lugs each projecting radially outward from the inner tread. Each of the lugs has a trailing edge, a leading edge that contacts the ground before the trailing edge as the tire rotates about the axis of rotation in a direction of travel, and a ground-contacting surface positioned between the leading edge and the trailing edge, the leading edge having a curvilinear contour that is free of outside edges.

A pneumatic tire in accordance with the invention has lugs each with a curvilinear leading edge lacking outside corners. The elimination of outside corners eliminates structures that would otherwise operate as stress concentration points. As a result, stress lines are less likely to develop under high loading conditions, such as hard surface roading, which reduces the incidence of cracking and tearing and increases tire durability. A pneumatic tire constructed in accordance with the principles of the invention has a significantly increased lug contact area or net-to-gross ratio proximate the equatorial plane of the tire. The concomitant increase in the circumferential lug width significantly increases lug stability. Moreover, the lug pattern layout permits the number of lugs per unit tire circumference or pitch number to be increased, as compared with conventional pneumatic tires used in row-crop field sprayer service, for maximizing the contact area to improve performance under conditions of high loading. Pneumatic tires constructed in accordance with the principles of the invention provide a significant load-carrying capacity without sacrificing attributes such as wet and dry traction, tread cleaning and hard surface roading. In addition, pneumatic tires constructed in accordance with the principles of the invention improve ride and handling performance in hard surface roading by virtue of the increased circumferential lug overlap as compared with conventional pneumatic tires used in row-crop field sprayer service.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a pneumatic tire according to the principles of the invention.

FIG. 2 is an end view of the pneumatic tire of FIG. 1.

FIG. 3 is a side view of the pneumatic tire of FIG. 1.

FIG. 4 is an enlarged view of a portion of FIG. 2.

FIG. 5 is a cross-sectional view of the pneumatic tire of FIG. 1.

FIG. 6 is a top view of a single lug of the tire of FIG. 4.

### DEFINITIONS

“Axial” and “axially” means the lines or directions that are parallel to the axis of rotation of the tire.

“Axially Inward” means in an axial direction toward the equatorial plane.

“Axially Outward” means in an axial direction away from the equatorial plane.

“Bead” means the circumferentially substantially inextensible metal wire assembly that forms the core of the bead area, and is associated with holding the tire to the rim.

“Carcass” means the tire structure apart from the belt structure, tread, undertread, and sidewall rubber over the plies, but including the beads.

“Casing” means the carcass, belt structure, beads, sidewalls, and other components of the tire excepting the tread and the undertread.

“Circumferential” means lines or directions extending along the perimeter of the surface of the annular tread perpendicular to the axial direction.

“Equatorial Plane” (EP) means the plane perpendicular to the tire's axis of rotation and passing through the center of its tread.

“Footprint” means the contact patch or area of contact of the tire tread with a flat surface at zero speed and under normal load and pressure.

“Inner” means toward the inside of the tire.

“Lateral Edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Lugs” refer to discontinuous radial rows of tread rubber in direct contact with the road surface.

“Net-to-Gross Ratio” means the ratio of the normally loaded and normally inflated tire tread rubber that makes contact with a hard flat surface, divided by the area of the tread, including non-contacting portions such as grooves as measured around the entire circumference of the tire.

“Outer” means toward the tire's exterior.

“Pitch” means a section of the tread in the circumferential direction that is repeated around the outer circumference of the tire. Normally, a pitch contains a load-bearing element or lug that contact the road surface and an adjacent channel which separates adjacent lugs.

“Pneumatic Tire” means a laminated mechanical device of generally toroidal shape, usually an open-torus, having beads and a tread and made of rubber, chemicals, fabric and steel or other materials. When mounted on the wheel of a motor vehicle, the tire through its tread provides traction and contains the fluid that sustains the vehicle load.

“Radial” and “Radially” mean directions radially toward or away from the axis of rotation of the tire.

“Section Height” (SH) means the radial distance from the nominal rim diameter to the outer diameter of the tire at its equatorial plane.

“Section Width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Shoulder” means the upper portion of sidewall just below the tread edge.

“Sidewall” means that portion of a tire between the tread and the bead area.

“Trailing” refers to a portion or part of the tread that contacts the ground last, with respect to a series of such parts or portions, during rotation of the tire in the direction of travel.

“Tread” means a molded rubber component which, when bonded to a tire casing, includes that portion of the tire that comes into contact with the road when the tire is normally inflated and under normal load.

“Tread Width or Tread Arc Width” means the arc length of the tread surface in the axial direction, that is, in a plane parallel to the axis of rotation of the tire.

### DETAILED DESCRIPTION

Although the invention will be described next in connection with certain embodiments, the invention is not limited to practice in any one specific type of row-crop field sprayer. It is contemplated that the pneumatic tires of the invention can be used with a variety of agricultural machinery having a high center of gravity and a large mass, including but not limited to row-crop field sprayers. Exemplary row-crop field sprayers with which the pneumatic tires of the invention can be used are commercially available, for example, from the Model 4710 and Model 6700 Self-Propelled Sprayers manufactured by John Deere (Moline, Ill.) and the New Holland Model SF550 self-propelled sprayer manufactured by CNH Global N.V. (Lake Forest, Ill.), and such commercially available row-crop field sprayers can be equipped with pneumatic tires constructed in accordance with the present invention. The description of the invention is intended to cover all alternatives, modifications, and equivalent arrangements as may be included within the spirit and scope of the invention as defined by the appended claims.

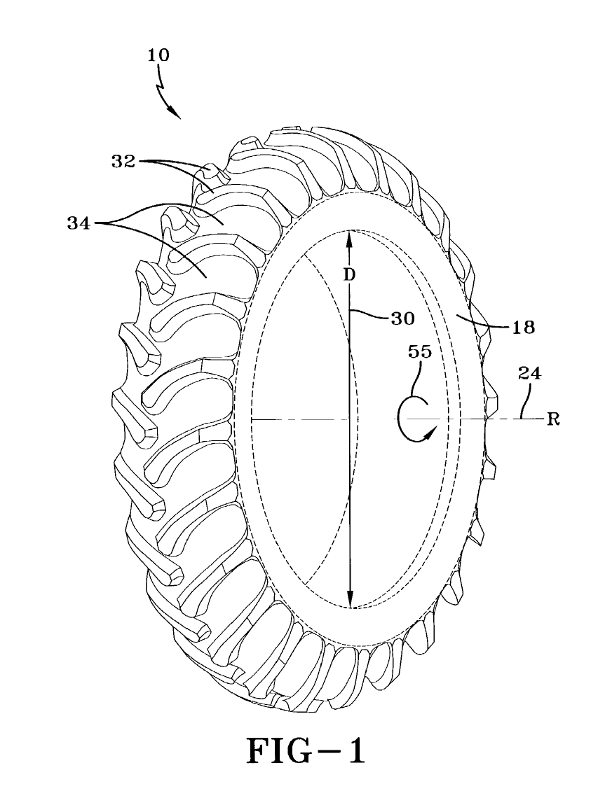

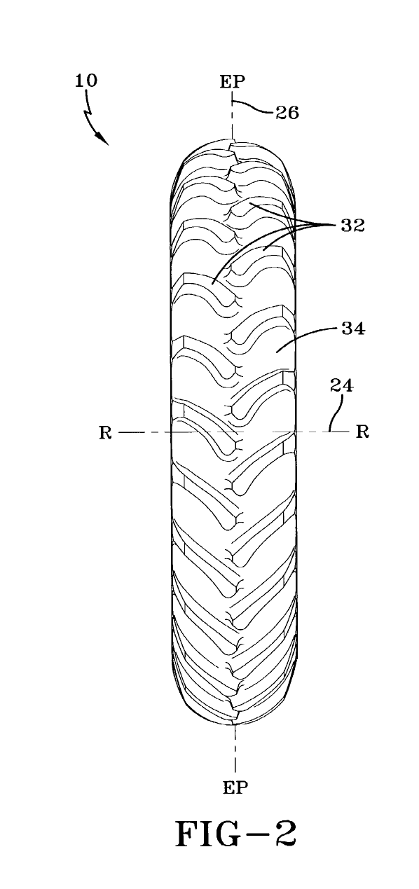

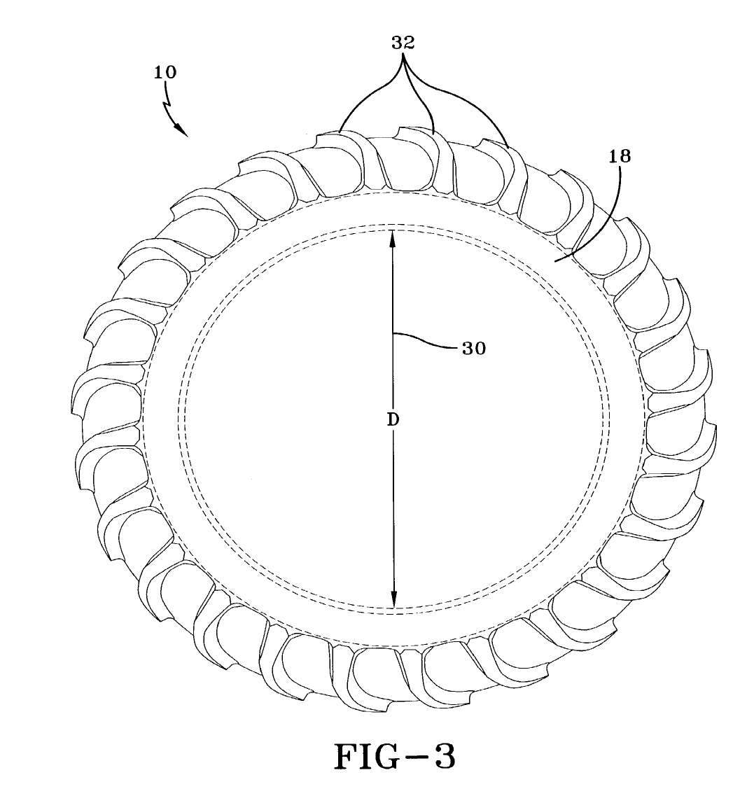

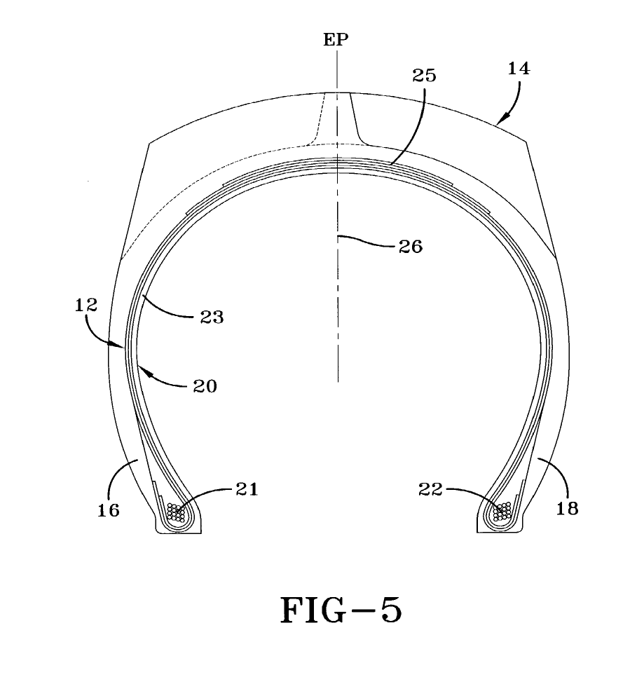

With reference to FIGS. 1-5, a pneumatic agricultural tire 10 constructed according to the principles of the invention includes a casing 12 and a tread 14. Tire 10 has an axis of rotation (R) 24, an equatorial plane (EP) 26, a maximum section width (SW) 28, and a rim diameter (D) 30. Casing 12 includes a pair of sidewalls 16, 18, a cord-reinforced rubber-coated carcass 20 and a pair of annular beads 21, 22. Carcass 20 includes one or more carcass plies 23 extending circumferentially about the axis of rotation 24 of the tire anchored at opposite ends to a corresponding one of beads 21, 22 and one or more belt plies 25 disposed radially outward from the carcass plies 23.

Tread 14 includes a pattern of ground-engaging lugs 32 disposed radially outward of the carcass 20, in which each of the lugs 32 projects radially outwardly from an inner tread 34, which extends circumferentially about the tire 10. The lugs 32 have a depth measured relative to the inner tread 34, which may be the depth classified as an R1 depth by the Tire and Rim Association, Inc. (Copley, Ohio). Discharge channels 40 between adjacent pairs of the lugs 32 extend axially toward a corresponding one of two opposite shoulders or lateral edges 42, 44 of tread 14 for clearing accumulated mud and the like from the volumetric space between the lugs 32.

The lugs 32 are arranged into two sets 36, 38 that extend circumferentially about the tread 14 with a uniform pitch. The sets 36, 38 of lugs 32 are symmetrical relative to the equatorial plane 26 or, equivalently, symmetrically positioned between the lateral edges 42, 44. Each lug 32 of each set 36, 38 has an outer lateral wall 46 that depends transversely from a radially-outermost ground-contacting surface 48 to merge with a corresponding one of the two sidewalls 16, 18 at the lateral edges 42, 44. Each lug 32 has a leading wall 50 that intersects surface 48 along a leading edge 51, an inner lateral wall 52, and a trailing wall 54 that intersects surface 48 along a trailing edge 56. Each of the walls 50, 52 and 54 extends radially inward from surface 48 to the inner tread 34.

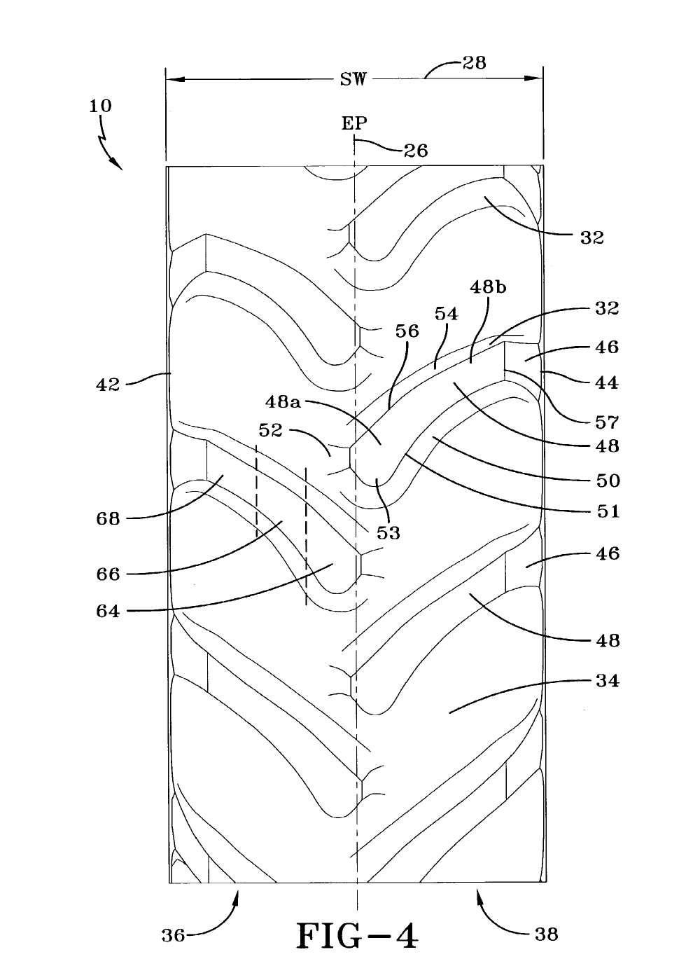

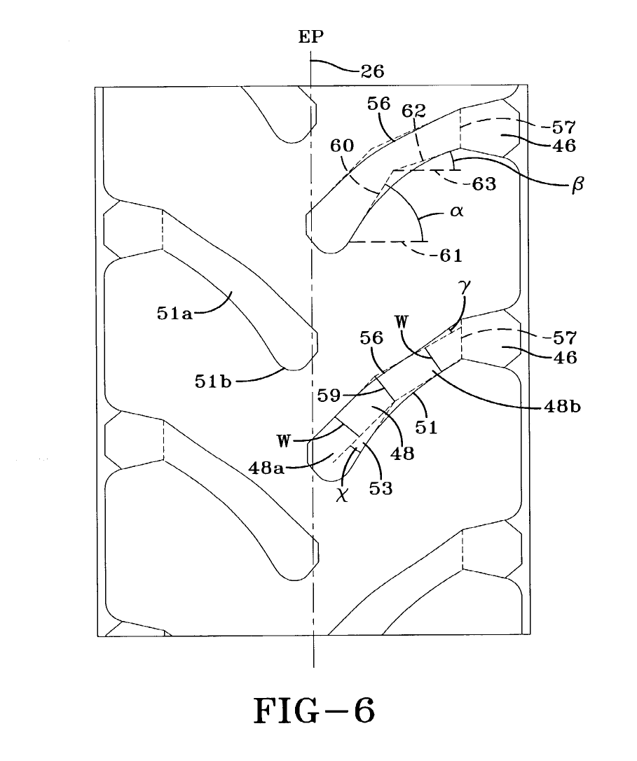

With reference to FIGS. 4 and 6, leading wall 50 is a smooth curvilinear surface and leading edge 51 is a smooth curvilinear line each free of outside corners. The elimination of outside corners from leading wall 50 removes structures from tire 10 that would otherwise serve as stress concentration points that are a potential source for the development of stress lines. As a result, tire 10 has a reduced likelihood of experiencing cracking and tearing and has an improved tire durability under high loading conditions, such as hard surface roading. In particular, leading edge 51 has a concave curve segment 51a and a convex curve segment 51b adjoining the concave curve segment 51a. The concave curve segment 51a extends along at least a majority of the length of leading edge 51.

The radially-outermost ground-contacting surface 48 of each lug 32 may be partitioned into an inner section 48a and an outer section 48b. Outer section 48b extends generally laterally from a junction 57 with lateral wall 52 approximately one-half of the distance from junction 57 to the equatorial plane 26. Inner section 48a extends inwardly from a junction 59 with outer section 48b toward the equatorial plane 26 and extends approximately one-half of the distance from the junction 57 to the equatorial plane 26. The tread 14 is directional in that the tire 10 is designed to rotate about axis of rotation 24 in the rotational direction indicated by arrow 55 (FIG. 1) such that leading edge 51 of each lug 32 contacts the ground before the trailing edge 56.

With continued reference to FIGS. 4 and 6, sections 48a and 48b are inclined relative to equatorial plane 26 with different inclination angles. Specifically and with regard to section 48a, a tangent line 60 intersecting leading edge 51 at the inflection point where the curvature of leading edge 51 changes from concave to convex is inclined at an angle, α, of about 61°±2°, measured relative to an axial line 61 extending perpendicular to the equatorial plane 26. A lobe 53 is defined on section 48a proximate to the equatorial plane 26. With regard to section 48b, a tangent line 62 intersecting leading edge 51 at junction 57 is inclined at an angle, β, of about 29°±2°, measured relative to an axial line 63 extending perpendicular to equatorial plane 26. This set of angles provides a significant circumferential lug overlap that improves ride and handling performance in hard surface roading. For example, the lugs 32 operate for reducing vibration during hard surface roading. The lesser inclination of tangent line 62 operates for improving performance parameters, such as traction, of pneumatic tire 10 when operating on a soft surface, such as ground. The steeper inclination angle of tangent line 60 increases the mechanical bracing and deflection resistance of lug 32 to a circumferentially-directed force result from surface 48 contacting the ground. In other words, each lug 32 can apply a greater stiffening force opposing the ground-contact force due to the inclination angle of tangent line 60.

With continued reference to FIG. 4, a portion of the inner section 48a crosses the equatorial plane 26 near the lateral wall 52 such that each lug 32 extends in an axial direction over 50% of the maximum section width 28. As a result, the lugs 32 are self-reinforcing by operating to stabilize one another due to the circumferential overlap in the tire footprint among adjacent lugs 32. The constructive reinforcement of adjacent lugs 32 significantly reduces tire vibration during hard surface roading because each lug 32 operates to stabilize an adjacent later-contacting lug 32, which are less likely to deflect as a result of surface contact as each lug 32 serially enters and exits the elliptical zone defined by the tire footprint. However, the extent of the overlap is limited so that the cleaning of soil from between the channels 40 between adjacent pairs of lugs 32 is not significantly affected.

Section 48b of surface 48 has an approximately uniform width, W, that is increased by a slight flaring, γ, in the circumferential direction of less than about 3° and is present for aesthetic purposes. Section 48a of surface 48 is flared with a circumferential dimension that increases in a direction from junction 59 toward the equatorial plane 26. As a result, the dimension of section 48a in the circumferential direction is significantly greater than the width of section 48b. The flaring of section 48a increases the effective circumferential dimension of lug 32 near the equatorial plane 26 and cooperates in providing lobe 53. The flaring of section 48a may be, for example, at an angle, χ, of about 13.5°±2°. The flaring of section 48a increases the surface or lug contact area proximate the equatorial plane 26, which increases the load-carrying capability of the pneumatic tire 10 on hard and soft surfaces. It follows that the increased lug contact area effectively increases the net-to-gross ratio of tire 10 relative to conventional pneumatic tires for service with row-crop field sprayers. The increase in the circumferential lug width of section 48a also significantly enhances lug stability against deflection.

The presence of lobe 53 causes the apportionment of the net-to-gross ratio to vary as compared with a lug 32 having a uniform circumferential dimension or width. Specifically, tread 14 may be apportioned into three circumferential regions or zones, 64, 66 and 68, each of which extends one-third of the perpendicular axial distance between junction 57 and a junction between surface 48 and surface 52. The proportion of the net-to-gross ratio provided by a portion of surface 48 encompassed by zone 64 to the net-to-gross provided by surface 48 encompassed by zone 68 is greater than 1.29, and typically is about 1.55 or larger. These values are significantly higher than the same ratio for conventional pneumatic tires intended for row-crop sprayer service. The net-to-gross ratio of tread 14, including all three zones 64, 66, and 68, is greater than 24% and, in certain embodiments, is about 27% or larger.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of applicants' general inventive concept.

What is claimed is:

1. An agricultural pneumatic tire comprising:
a casing having an axis of rotation and an equatorial plane perpendicular to the axis of rotation; and
a tread disposed radially outward of the casing, the tread including an inner tread and a plurality of lugs,
each of the lugs having a trailing wall, a leading wall that is circumferentially spaced about the axis of rotation from the trailing wall, a first side edge proximate to the equatorial plane, a second side edge connected by the leading and trailing walls with the first side edge, a ground-contacting surface circumferentially between the leading wall and the trailing wall, and a lateral wall connecting the leading and trailing walls, the leading wall being free of outside corners and intersecting the ground-contacting surface along a curvilinear leading edge having a concave segment and a convex segment, the leading edge inclined at an angle of 61°±2° relative to a first line perpendicular to the equatorial plane at an inflection point between the concave and convex segments, and the leading edge inclined at an angle of 29°±2° to a second line perpendicular to the equatorial plane at a junction of the ground-contacting surface with the lateral wall, and wherein the tread includes at least first, second and third regions extending circumferentially about the tread, and each of the first, second and third regions extending one-third of an axial distance measured between the first and second side edges of each of the lugs,
the first region being proximate to the equatorial plane, the second region being between the first and third regions,
wherein the first region has a net-to-gross ratio that is at least 29% greater than a net-to-gross ratio of the third region,
wherein the casing includes sidewalls separated by a section width, and each of the lugs extends parallel to the axis of rotation from the lateral wall over 50% of the section width such that the lugs are self-reinforcing with circumferential overlap by adjacent lugs, and
wherein the ground-contacting surface has a lobe flared with a circumferential dimension that increases in an axially inward direction toward the equatorial plane, and the lobe of the ground-contacting surface is flared at an angle of 13.5°±2°.

2. The agricultural pneumatic tire of claim 1, wherein the net-to-gross ratio of the first region is at least about 55% greater than the net-to-gross ratio of the third region.

3. The agricultural pneumatic tire of claim 2, wherein a net-to-gross ratio of the tread is greater than about 24%.

4. The agricultural pneumatic tire of claim 3, wherein the net-to-gross ratio of the tread is about 27%.

5. The agricultural pneumatic tire of claim 4, wherein the concave segment extends along a majority of a length of the curvilinear leading edge.

6. The agricultural pneumatic tire of claim 5, wherein the convex segment is positioned proximate to the equatorial plane and is separated from the lateral wall by the concave segment.

7. The agricultural pneumatic tire of claim 6, wherein the lobe of the ground-contacting surface intersects the curvilinear leading edge along the convex segment of the curvilinear leading edge and along a portion of the concave segment of the curvilinear leading edge.
